(19) United States
(12) Patent Application Publication
(10) Pub. No.: US 2012/0211572 A1
(43) Pub. Date: Aug. 23, 2012

(54) Strainer System for Agricultural Sprayer

(75) Inventor: John Peterson, Jackson, MN (US)

(73) Assignee: AGCO CORPORATION, Duluth, GA (US)

(21) Appl. No.: 13/337,180

(22) Filed: Dec. 26, 2011

Related U.S. Application Data
(60) Provisional application No. 61/427,250, filed on Dec. 27, 2010.

(51) Int. Cl. A01G 25/09; B67D 7/08

(52) U.S. Cl. 239/1; 239/71

(57) ABSTRACT

A spray system detects the pressure differential across a plurality of spray section filters and determines whether the resulting values meet predetermined criteria. A sensor may be provided at each boom spray section to determine a differential pressure across an associated filter. A pressure evaluator module may receive the pressure values and determine whether to trigger an alarm.

### CROSS-REFERENCE TO RELATED APPLICATIONS

Under provisions of 35 U.S.C. §119(e), Applicant claims the benefit of U.S. provisional application No. 61/427,250, filed Dec. 27, 2010, which is incorporated herein by reference.

### BACKGROUND

Agricultural sprayers typically employ a boom having a plurality of boom sections with sprayers configured to spray chemical in a desired pattern. The sprayers employ orifices to create a desired distribution pattern and dispense a desired amount of chemical based on the pressure of the system. These orifices are small and susceptible to plugging, which tends to affect the amount of chemical dispensed, the spray pattern, or both. Strainers are often employed in an effort to prevent the plugging of the orifices. Some operators prefer to have an independent strainer for each section/supply line of the sprayer, but doing so results in several problems. For example, the strainers tend to plug at different rates resulting in uneven and/or irregular spray patterns along the boom and variations in product density and volume can also cause undesirable differences in the spray distribution.

### BRIEF DESCRIPTION OF THE DRAWINGS

FIG. 1 shows an example embodiment of a strainer system for an agricultural vehicle.

FIG. 2A shows an exploded cutaway view of a strainer assembly incorporating a differential pressure sensor in accordance with an example embodiment of the invention.

FIG. 2B shows a cutaway view of a strainer assembly incorporating a differential pressure sensor in accordance with an example embodiment of the invention.

FIG. 3 shows a schematic diagram of a strainer system in accordance with an example embodiment of the invention.

FIG. 4 shows a user interface in accordance with an example embodiment of the invention.

FIGS. 5A-5D show a user interface in accordance with an example embodiment of the invention in which various alert messages are displayed in response to the detected pressures across various spray section filters.

FIG. 6 shows a flow diagram of an example method of the invention.

### OVERVIEW

In an example embodiment, a boom spray system includes a boom having a plurality of boom spray sections. A filter is provided for each spray section and a differential pressure sensor determines the pressure across the filter. A pressure evaluator module receives the pressure data and determines whether the data meet predetermined criteria. If the criteria is not met, then an alarm is triggered to alert an operator. An example method includes: detecting a pressure across the filters of a plurality of spray sections of a boom sprayer and determining whether the detected pressures meet criteria of a predetermined scheme. The method may further include triggering an alert if the detected pressures do not meet the parameters.

### DETAILED DESCRIPTION

As required, example embodiments of the present invention are disclosed. The various embodiments are meant to be non-limiting examples of various ways of implementing the invention and it will be understood that the invention may be embodied in alternative forms. The present invention will be described more fully hereinafter with reference to the accompanying drawings in which like numerals represent like elements throughout the several figures, and in which example embodiments are shown. The figures are not necessarily to scale and some features may be exaggerated or minimized to show details of particular elements, while related elements may have been eliminated to prevent obscuring novel aspects. The specific structural and functional details disclosed herein should not be interpreted as limiting, but merely as a basis for the claims and as a representative basis for teaching one skilled in the art to variously employ the present invention. For example, while the exemplary embodiments are discussed in the context of an agricultural vehicle, and more specifically a sprayer vehicle, it will be understood that the present invention is not limited to that particular arrangement.

The materials described hereinafter as making up the various elements of the invention are intended to be illustrative and not restrictive. Many suitable materials that would perform the same or a similar function as the materials described herein are intended to be embraced within the scope of the invention. Such other materials not described herein can include, but are not limited to, for example, materials that are developed after the development of the invention.

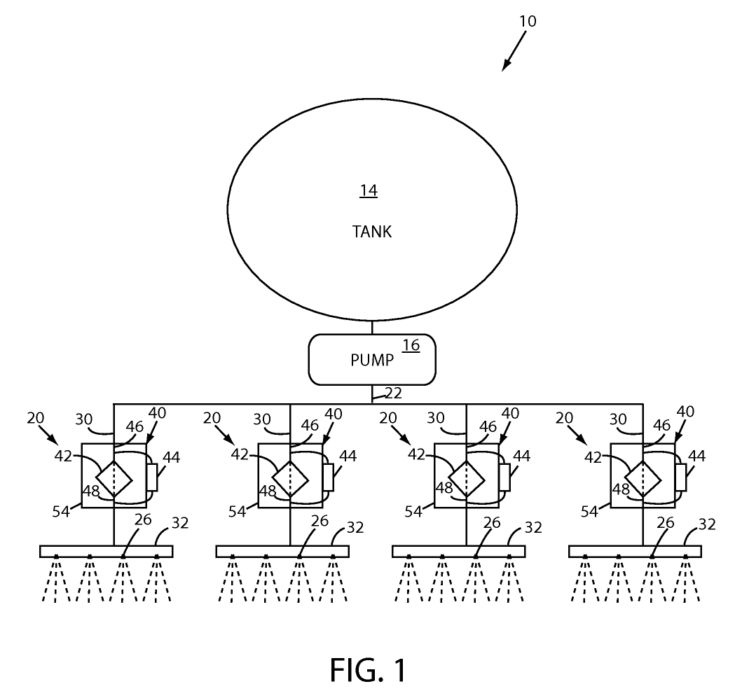

Referring now to the drawings, FIG. 1 shows a schematic diagram of a vehicular application system according to principles of the present invention. The vehicular application system 10 may be used in farm chemical delivery systems, either self-propelled or pulled by another vehicle. A tank 14 and a pump assembly 16 may be carried on a vehicle. The pump 16 may be used to conduct fluid from the tank 14 to a plurality of boom spray sections 20 via a conduit 22. The boom spray sections may include a plurality of nozzles 26 through which fluid is sprayed in a desired spray pattern as known to one of ordinary skill in the art. Each boom spray section may have a conduit section 30 that is coupled to a manifold 32 to provide fluid to the nozzles 26. The flow of fluid may be controlled by a control system that manipulates the pump 16.

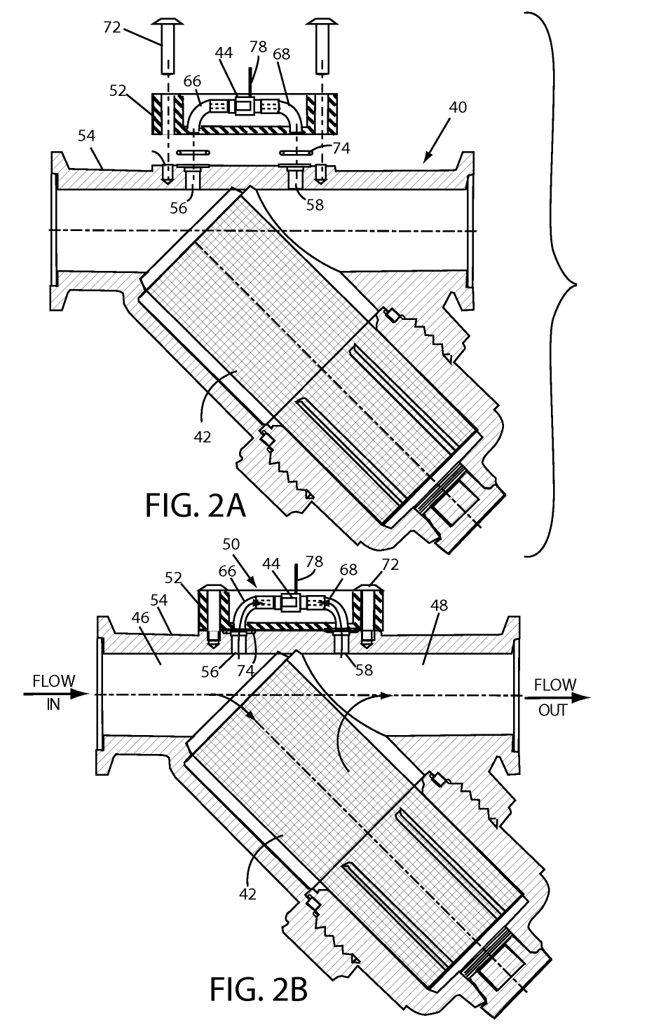

A strainer assembly 40 (FIGS. 1 and 2) is provided at each spray section 20 and receives fluid from the conduit section 30 and provides the fluid to the manifold 32. The strainer assembly 40 may include a housing 54 and a filter 42 within the housing the filters fluid flowing through the strainer assembly 40. The strainer assembly may include a differential pressure sensor 44 provided at the strainer 40 and configured to determine the pressure at each side of the filter 42, such as an upstream side 46 and a down stream side 48 of the filter. The detected pressures give an indication as to whether the filter 42 is plugged. For example, a high relative upstream pressure value will be an indication that the filter 42 is plugged, which may result in an undesirable spray pattern and/or spray volume. The relative values of the differential pressure across the filters 42 may be used to determine if one or more filters 42 is plugged. For example, there may be a situation where one pressure sensor indicates a high pressure value which is an indication of an individual filter being plugged. If each of the sensors detects a high pressure value then each of the filters 42 may be plugged.

In the example embodiment shown in FIGS. 2A-2B, a strainer 40 may be in the form of a Y-type strainer in which fluid flows into an upstream portion 46, through the filter 42 and into a downstream portion 48. A sensor assembly 50 may be a surface mount differential pressure sensor coupled to the strainer housing 54 and configured to detect pressure at both the upstream 46 and downstream portions 48. In one example embodiment, the sensor assembly 50 may be a 20 PC series available from Honeywell. The sensor assembly 50 may include a sensor 44 housed within a casing 52 that is configured for attachment with a wall of the strainer housing. Openings 56, 58 may be provided in the strainer housing 54 to allow fluid flow through elbows 66, 68 of the sensor assembly where the associated pressures are detected by the sensor 44. The casing 52 may be coupled to the strainer housing 54 by screws 72 or other fasteners and O-rings 74 may be provided to seal the junction of the elbows 66, 68 with the openings 56, 58. The sensor 44 may include a connector 78 for coupling to a system of the vehicle, such as a CAN bus as known in the art, to provide the pressure information to a controller as discussed in more detail below.

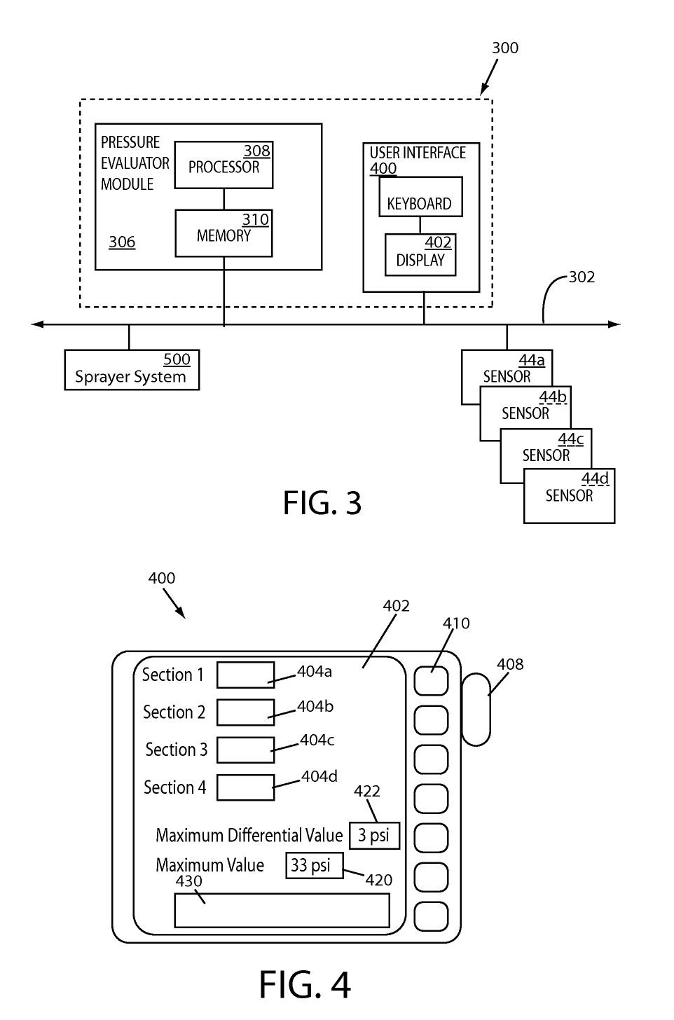

FIG. 3 shows an example embodiment of a system 300 of the invention in its operating environment. One or more sensors 44a-n are provided that detect a differential pressure across a filter at a spray section of a spray boom. The sensors 44 are communicatively coupled to a CAN bus 302 for communication with other components such as a spray system 500 that may include various valves, controllers, switches (not shown) or the like for manipulating the movement of fluid through the sprayer. A pressure evaluator module (PEM) 306 is communicatively coupled to the CAN bus 302 to receive data from the sensors 44. The PEM 306 may be hardware, software, and/or firmware and be configured to received the pressure data provided by the sensors 44 and determine whether the data meets criteria of a predetermined scheme. For example, under one scheme a determination is made as to whether one or more of the detected pressures is greater than a threshold value. In an example embodiment, the PEM 306 comprises a processor 308 configured to execution instructions and a memory 310 for storing instructions and other data. For example, the predetermined scheme used by the processor 308 may be stored in the memory 310 and retrieved and executed by the processor 308.

A user interface 400 may also be provided to give an operator a means to enter a particular scheme to be used by the PEM 306 and to display relevant data to a user. For example, as shown in FIG. 4 a user interface 400 may include a display 402 with fields 404a-n to indicate the various pressure values detected by the sensors 44a-n. The user interface 400 may also include a scroll wheel 408 and buttons 410 for allowing a user to enter or select values to be used in the predetermined scheme executed by the PEM 306. For example, a user may enter a desired maximum pressure value 420 to be used by the PEM in determining whether particular criteria are met. In addition, a maximum differential value 422 may be entered by a user and represent the maximum difference in the pressures at each sensor. A warning field 430 may also be provided in order to indicate to a user various alarms triggered by the PEM 306. For example, the PEM 306 may receive pressure data detected by the sensors 44 and determine whether one or more pressure values exceed a predetermined threshold. such as the maximum value 422 provided by a user. If so, then the PEM 306 may trigger an alarm, such as the display of a message in the warning field 430. The user interface 400 allows a user to easily adjust the system for different crops, chemicals, etc.

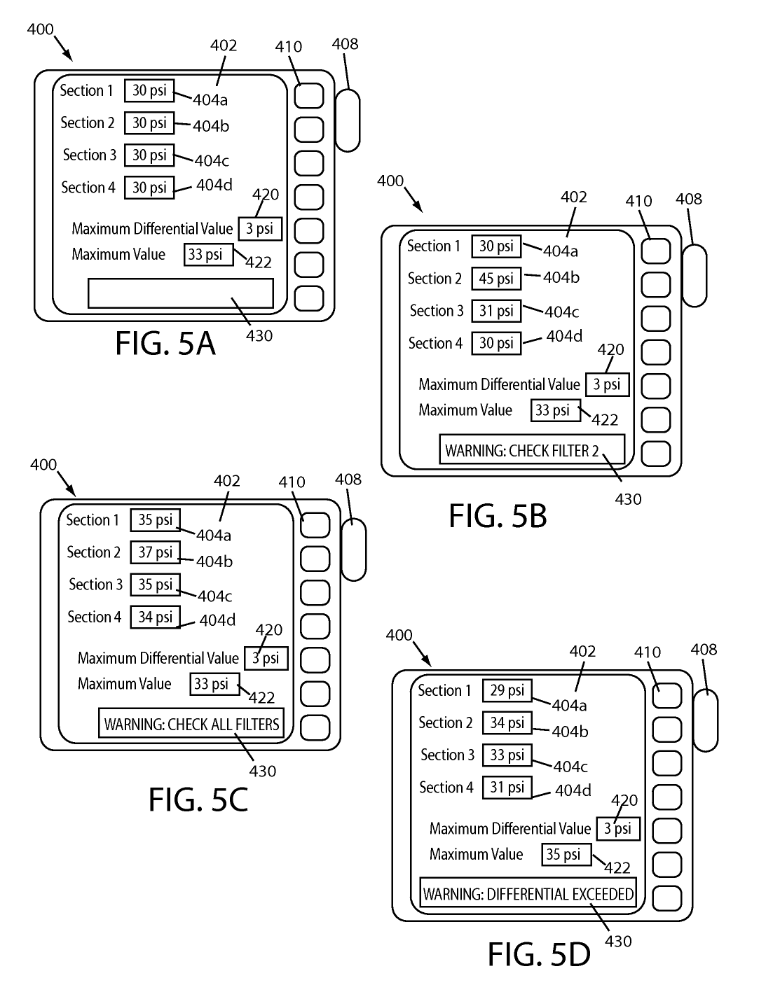

FIGS. 5A-5D show examples of the user interface when particular pressure values are detected by the sensors 44. In this example, the predetermined scheme executed by the PEM 306 is determining whether one or more detected pressure values exceeds a predetermined maximum value, which in this case is 33 psi. Because each detected pressure value is 30 psi which is less than the threshold value of 33 psi the PEM 306 determines that the pressure are within the predetermined criteria and no alert is triggered. In FIG. 5B, the sensor 44 associated with boom spray section 2 detects a pressure of 45 psi across the associated filter. In that case, the detected pressure is greater than the allowed maximum value of 33 psi and the PEM 306 triggers an alert. For example, the PEM 306 may send a signal to the display 402 to generate the warning “CHECK FILTER 2.”

In the situation shown in FIG. 5C, each detected pressure is greater than the maximum psi. In that case, the PEM 306 triggers an alert to display the message “CHECK ALL FILTERS” or “HIGH FILTER PRESSURE—REDUCE SPEED!” or “HIGH FILTER PRESSURE—INCREAE STRAINER SIZE.” In the situation in FIG. 5D, each detected pressure is less than a predetermined maximum value of 35 psi. However, the PEM 306 may execute a predetermined scheme that compares the difference in the various pressure values to determine whether any two values are different by more than a threshold value. In this case, a maximum differential value is set a 3 psi which is exceeded by the difference between the section 1 value (29 psi) and the section 3 value (33 psi). In that case, the PEM 306 triggers an alert to display “DIFFERENTIAL EXCEEDED” or some other warning.

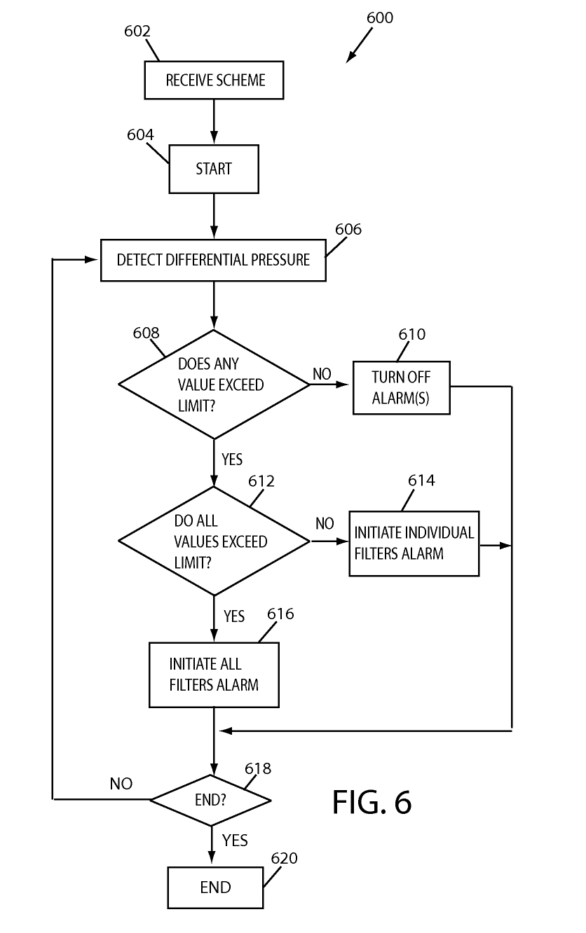

FIG. 6 shows an example method 600 of the invention. At block 602 a scheme is received from a user. For example, a user may use the user interface 400 to provide a maximum desired value for a pressure across a filter of a boom spray section. Other schemes could be used, such as a maximum differential value between the various boom spray filters. At block 604 the spray system is activated. For example, a spray controller 500 may instruct a pump 16 to send fluid through the conduit 22 of a boom spray system so that fluid is sent through filters 42 of a plurality of boom spray sections and through various associated spray nozzles 26.

At block 606 the differential pressure across the filters 42 is detected. For example, sensors 44a-n may be provided at strainers 40 that house the filters 42 and detect an upstream and downstream pressure across the filters 42. At block 608 a determination is made as to whether the detected pressures are in accordance with a predetermined scheme. For example, the detected pressure values across the various filters 42 may be provided to a pressure evaluator module (PEM) 306 which determines whether the pressures meet predetermined criteria. In this example, the criteria is a maximum value. If none of the pressure values exceeds the predetermined maximum value then at block 610 any existing alarms that may be activated are turned off.

If there is at least one pressure value that exceeds the predetermined maximum value at block 608 then a block 612 determines whether all pressure values exceed the predetermined maximum value. For example, the PEM 306 may compare the detected values provided by the sensors 44 with the predetermined maximum value. If fewer than all of the sensors exceed the predetermined maximum value, then at block 614 an individual alarm is triggered. For example, the PEM 306 may send a signal to the display 402 of the user interface to display the warning message similar to that shown in FIG. 5B. If all of the pressure values exceed the predetermined maximum value, then at block 616 an all filters alarm may be triggered. For example, the PEM 306 may send a signal to display the message shown in FIG. 5C.

At bock 618 a check may be made as to whether the process should be ended. For example, a user may power down the spray system or use the user interface to stop the pressure monitoring. If the process should be ended then at block 620 the process is ended. Otherwise, the process continues at block 606 with the detection of the cross filter pressures. It should be noted that in this example method block 602 is shown as a first step in the process, a user could provide the various schemes for analyzing the pressure values at some other time.

The present system thus allows a user to employ filters at each boom spray section and monitor each section to ensure that a desired spray is being provided. It should be noted that a variety of different schemes could be employed by the PEM. For example, the detected pressures across the various could be used and an alarm triggered if one of the filters is outside of a particular range, such as a standard deviation of the values or other statistical analysis could be employed as part of the scheme.

In addition, although the PEM is shown as a separate element, the PEM could be a part of another component of a sprayer such as a main processor commonly employed on agricultural sprayers.

Furthermore, while the various sensors were shown in the example embodiment as a single pressure differential sensor, in other embodiments multiple sensors could be employed, such as a first pressure sensor on a first side of the filter and a second sensor on a second side of the filter. In addition, whereas the sensor is shown as part of the strainer housing, the sensor could be incorporated into the filter housing or added as a bolt on. Preferably the various parts are made of material resistant to agricultural chemicals such as EDPM and/or Viton®.

What is claimed is:

1. A spray system for an agricultural sprayer, comprising:
a spray boom having a plurality of spray sections, each spray section having a filter through which a fluid flows;
a pressure sensor at each spray section configured to detect a differential pressure across the filter of the spray section; and
a pressure evaluator configured to receive pressure data from each of said pressure sensors and determine whether the pressure data meets a predetermined criteria.

2. The spray system of claim 1, further comprising:
a user interface configured to receive a predetermined scheme from a user.

3. The spray system of claim 1, further comprising a display configured to indicate the pressure data.

4. The spray system of claim 1, wherein the pressure evaluator is configured to trigger an alert if the pressure data does not meet the predetermined criteria.

5. The spray system of claim 1, wherein the pressure evaluator is configured to trigger an alert if the pressure data of at least one pressure sensor exceeds a predetermined threshold value.

6. The spray system of claim 1, wherein the pressure evaluator is configured to trigger an alert if the pressure data of all the pressure sensors exceeds a predetermined threshold value.

7. An apparatus, comprising:
a spray pressure evaluator configured to receive pressure data across two or more spray section filters of a spray boom and determine whether the pressure data is in conformance with a predetermined scheme.

8. The apparatus of claim 7, wherein the pressure evaluator is configured to determine whether a determined pressure across a filter is greater than a predetermined value.

9. The apparatus of claim 7, wherein the pressure evaluator is configured to determine whether the pressure across all filters is greater than a predetermined value.

10. The apparatus of claim 7, wherein the pressure evaluator is configured to trigger an alert if the pressure data across one filter exceeds a threshold value.

11. The apparatus of claim 7, wherein the pressure evaluator is configured to trigger an alert if the pressure data across all filters exceeds a threshold value.

12. The apparatus of claim 7, further comprising a user interface configured to receive input from a user to establish the predetermined scheme.

13. The apparatus of claim 7, further comprising a display to indicate an alarm if the detected pressure is not within the predetermined scheme.

14. A method, comprising:
detecting a differential pressure across a plurality of boom spray section filters of a spray boom; and
determining whether the detected pressures meet parameters of a predetermined scheme.

15. The method of claim 14, further comprising:
triggering an alert if the detected pressures do not meet the parameters.

16. The method of claim 14, wherein determining whether the detected pressures meet parameters of a predetermined scheme comprises determining whether at least one of the detected pressures exceeds a threshold value.

17. The method of claim 15, wherein the triggering an alert comprises triggering an individual filter alarm.

18. The method of claim 14, wherein determining whether the detected pressures meet parameters of a predetermined scheme comprises determining whether all of the detected pressures exceeds a threshold value.

19. The method of claim 18, further comprising triggering an all filters alarm if all of the detected pressures exceed a threshold value.

20. The method of claim 18, wherein determining whether the detected pressures meet parameters of a predetermined scheme comprises determining whether the differences between the detected pressures exceeds a predetermined value.
